(19) United States
(12) Patent Application Publication
(10) Pub. No.: US 2012/0176643 A1
(43) Pub. Date: Jul. 12, 2012

(54) Dynamic Alert Mechanism for Count-Constrained Interface Controls

(75) Inventors: Marianne L. Kodimer, Huntington Beach, CA (US); Hongfeng Wei, Cerritos, CA (US)

(73) Assignees: Toshiba Tec Kabushiki Kaisha, Shinagawa-ku (JP); Kabushiki Kaisha Toshiba, Minato-ku (JP)

(21) Appl. No.: 13/286,873

(22) Filed: Nov. 1, 2011

Related U.S. Application Data
(60) Provisional application No. 61/431,791, filed on Jan. 11, 2011.

(51) Int. Cl. G06F 3/048; G06F 3/12

(52) U.S. Cl. 358/1.15; 715/780

(57) ABSTRACT

There is disclosed a method and apparatus for providing count-constrained user interface controls. The user interface displays a user input field and a predetermined count limit of user input parameters for the user input field on a user interface on a display. Once user interaction with the user input field is accepted, the user interface is updated such that the predetermined count limit on the display one of (a) blinks if a total count of the user input parameters exceeds the predetermined count limit, (b) changes color if the total count of the user input parameters equals the predetermined count limit, and (c) returns to a default color matching other aspects of the user interface if the total count of the user input parameters is less than the predetermined count limit.

### RELATED APPLICATION INFORMATION

This patent claims priority from U.S. Provisional Patent Application No. 61/431,791 entitled “Dynamic Alert Mechanism for Count-Constrained User Interface Controls” filed Jan. 11, 2011.

### NOTICE OF COPYRIGHTS AND TRADE DRESS

A portion of the disclosure of this patent document contains material which is subject to copyright protection. This patent document may show and/or describe matter which is or may become trade dress of the owner. The copyright and trade dress owner has no objection to the facsimile reproduction by anyone of the patent disclosure as it appears in the Patent and Trademark Office patent files or records, but otherwise reserves all copyright and trade dress rights whatsoever.

### BACKGROUND

1. Field

This disclosure relates to user interfaces for computing devices.

2. Description of the Related Art

A multifunction peripheral (MFP) is a type of document processing device which is an integrated device providing at least two document processing functions, such as print, copy, scan and fax. In a document processing function, an input document (electronic or physical) is used to automatically produce a new output document (electronic or physical).

Documents may be physically or logically divided into pages. A physical document is paper or other physical media bearing information which is readable unaided by the typical human eye. An electronic document is any electronic media content (other than a computer program or a system file) that is intended to be used in either an electronic form or as printed output. Electronic documents may consist of a single data file, or an associated collection of data files which together are a unitary whole. Electronic documents will be referred to further herein as a document, unless the context requires some discussion of physical documents which will be referred to by that name specifically.

In printing, the MFP automatically produces a physical document from an electronic document. In copying, the MFP automatically produces a physical document from a physical document. In scanning, the MFP automatically produces an electronic document from a physical document. In faxing, the MFP automatically transmits via fax an electronic document from an input physical document which the MFP has also scanned or from an input electronic document which the MFP has converted to a fax format.

MFPs are often incorporated into corporate or other organization's networks which also include various other workstations, servers and peripherals. An MFP may also provide remote document processing services to external or network devices.

User interfaces are used in every user to computer interaction. One type of interaction, typically undertaken by system administrators is user management. User management is necessary in corporate or other organization's networks in order to maintain security of physical and electronic documents. A user login or user pin may be required before access to an MFP is granted. Various functions of an MFP may be disabled for some users and enabled for others.

User interface notification systems of the prior art are either insufficiently informative or interrupt and disturb the user when a limit on the amount of user input is reached. These limits maybe limits on a total number of characters in a text box or on the total number of selections of a set a user may identify. Notifications regarding these limits in the past have included informational labels with no warning system, popup message systems that disturb a user attempting to interact with the interface and inline message systems displayed only after an entire page of user input is found to exceed the maximum when acceptance of the input is requested. It would be best to provide a localized user notification of sufficient urgency that does not disturb the user's input into such systems.

### DESCRIPTION OF THE DRAWINGS

FIG. 1 is a diagram of an MFP system.

FIG. 2 is a block diagram of an MFP.

FIG. 3 is a block diagram of a computing device.

FIG. 4 is a block diagram of a software system for an MFP.

FIG. 5 is a count-constrained interface control.

FIG. 6 is a count-constrained interface control after the maximum count has been reached.

FIG. 7 is a count-constrained interface control once the count has been exceeded.

FIG. 8 is an alternative count-constrained interface control once the count has been exceeded.

FIG. 9 is a flowchart for the operation of the count-constrained interface control.

Throughout this description, elements appearing in figures are assigned three-digit reference designators, where the most significant digit is the figure number and the two least significant digits are specific to the element.

### DETAILED DESCRIPTION

Description of Apparatus

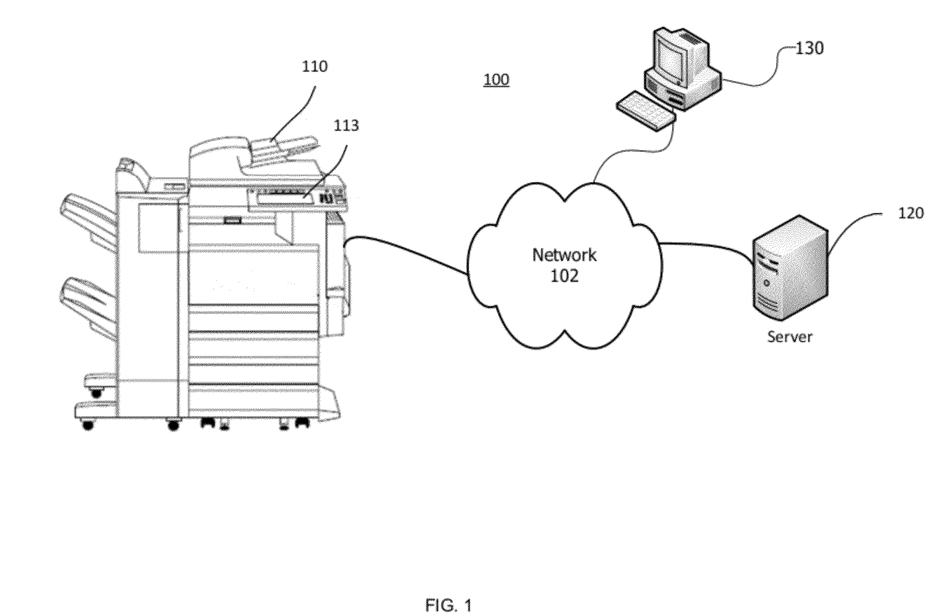

Referring now to FIG. 1 there is shown an MFP system 100. The system 100 includes an MFP 110, a server 120, and a client computer 130, all interconnected by a network 102. The system 100 may be implemented in a distributed computing environment and interconnected by the network 102.

The network 102 may be a local area network, a wide area network, a personal area network, the Internet, an intranet, or any combination of these. The network 102 may have physical layers and transport layers according to IEEE 802.11, Ethernet or other wireless or wire-based communication standards and protocols such as WIMAX®, BLUETOOTH®, the public switched telephone network, a proprietary communications network, infrared, and optical.

The MFP 110 may be equipped to receive portable storage media such as USB drives. The MFP 110 includes a user interface subsystem 113 which communicates information to and receives selections from users. The user interface subsystem 113 has a user output device for displaying graphical elements, text data or images to a user and a use input device for receiving user inputs. The user interface subsystem 113 may include a touchscreen, LCD display, touch-panel, alpha-numeric keypad and/or an associated thin client through which a user may interact directly with the MFP 110.

The server 120 is a server computer running software and connected to the network. The client computer 130 may be a PC, thin client or other device. The client computer 130 is representative of one or more end-user devices and may be considered separate from the system 100.

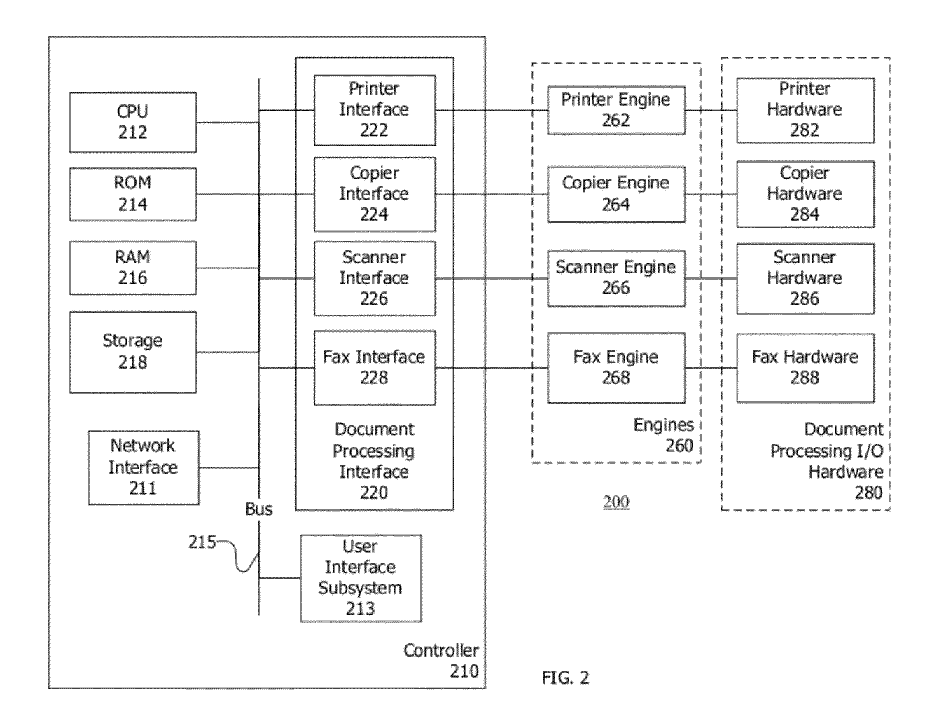

Turning now to FIG. 2 there is shown a block diagram of an MFP 200 which may be the MFP 110 (FIG. 1). The MFP 200 includes a controller 210, engines 260 and document processing I/O hardware 280. The controller 210 includes a CPU 212, a ROM 214, a RAM 216, a storage 218, a network interface 211, a bus 215, a user interface subsystem 213 and a document processing interface 220.

As shown in FIG. 2 there are corresponding components within the document processing interface 220, the engines 260 and the document processing I/O hardware 280, and the components are respectively communicative with one another. The document processing interface 220 has a printer interface 222, a copier interface 224, a scanner interface 226 and a fax interface 228. The engines 260 include a printer engine 262, a copier engine 264, a scanner engine 266 and a fax engine 268. The document processing I/O hardware 280 includes printer hardware 282, copier hardware 284, scanner hardware 286 and fax hardware 288.

The MFP 200 is configured for printing, copying, scanning and faxing. However, an MFP may be con1d to provide other document processing functions, and, as per the definition, as few as two document processing functions.

The CPU 212 may be a central processor unit or multiple processors working in concert with one another. The CPU 212 carries out the operations necessary to implement the functions provided by the MFP 200. The processing of the CPU 212 may be performed by a remote processor or distributed processor or processors available to the MFP 200. For example, some or all of the functions provided by the MFP 200 may be performed by a server or thin client associated with the MFP 200, and these devices may utilize local resources (e.g., RAM), remote resources (e.g., bulk storage), and resources shared with the MFP 200.

The ROM 214 provides non-volatile storage and may be used for static or fixed data or instructions, such as BIOS functions, system functions, system configuration data, and other routines or data used for operation of the MFP 200.

The RAM 216 may be DRAM, SRAM or other addressable memory, and may be used as a storage area for data instructions associated with applications and data handling by the CPU 212.

The storage 218 provides volatile, bulk or long term storage of data associated with the MFP 200, and may be or include disk, optical, tape or solid state storage. The three storage components, ROM 214, RAM 216 and storage 218 may be combined or distributed in other ways, and may be implemented through SAN, NAS, cloud or other storage systems.

The network interface 211 interfaces the MFP 200 to a network, such as the network 102 (FIG. 1), allowing the MFP 200 to communicate with other devices.

The bus 215 enables data communication between devices and systems within the MFP 200. The bus 215 may conform to the PCI Express or other bus standard.

While in operation, the MFP 200 may operate substantially autonomously. However, the MFP 200 may be controlled from and provide output to the user interface subsystem 213, which may be the user interface subsystem 113 (FIG. 1).

The document processing interface 220 may be capable of handling multiple types of document processing operations and therefore may incorporate a plurality of interfaces 222, 224, 226 and 228. The printer interface 222, copier interface 224, scanner interface 226, and fax interface 228 are examples of document processing interfaces. The interfaces 222, 224, 226 and 228 may be software or firmware.

Each of the printer engine 262, copier engine 264, scanner engine 266 and fax engine 268 interact with associated printer hardware 282, copier hardware 284, scanner hardware 286 and facsimile hardware 288, respectively, in order to complete the respective document processing functions. These engines may be software, firmware or a combination of both that enable the document processing interface 220 to communicate with the document processing I/O hardware 280.

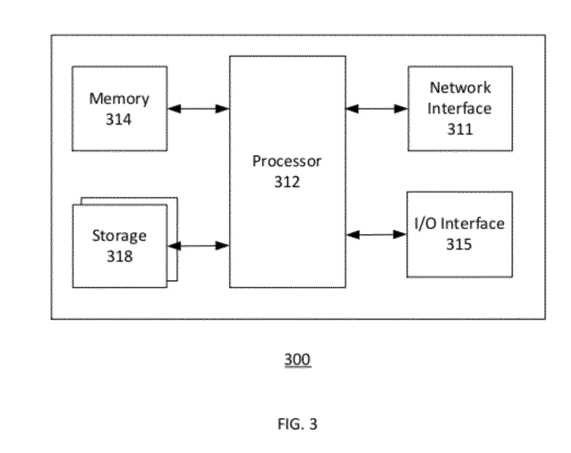

Turning now to FIG. 3 there is shown a computing device 300, which is representative of the server computers, client devices and other computing devices discussed herein. The controller 210 (FIG. 2) may also, in whole or in part, incorporate a general purpose computer like the computing device 300. The computing device 300 may include software and/or hardware for providing functionality and features described herein. The computing device 300 may therefore include one or more of: logic arrays, memories, analog circuits, digital circuits, software, firmware and processors. The hardware and firmware components of the computing device 300 may include various specialized units, circuits, software and interfaces for providing the functionality and features described herein.

The computing device 300 has a processor 312 coupled to a memory 314, storage 318, a network interface 311 and an I/O interface 315. The processor may be or include one or more microprocessors, field programmable gate arrays (FPGAs), application specific integrated circuits (ASICs), programmable logic devices (PLDs) and programmable logic arrays (PLAs).

The memory 314 may be or include RAM, ROM, DRAM, SRAM and MRAM, and may include firmware, such as static data or fixed instructions, BIOS, system functions, configuration data, and other routines used during the operation of the computing device 300 and processor 312. The memory 314 also provides a storage area for data and instructions associated with applications and data handled by the processor 312.

The storage 318 provides non-volatile, bulk or long term storage of data or instructions in the computing device 300. The storage 318 may take the form of a disk, tape, CD, DVD, or other reasonably high capacity addressable or serial storage medium. Multiple storage devices may be provided or available to the computing device 300. Some of these storage devices may be external to the computing device 300, such as network storage or cloud-based storage.

As used herein, the term storage medium corresponds to the storage 318 and does not include transitory media such as signals or waveforms.

The network interface 311 includes an interface to a network such as network 102 (FIG. 1).

The I/O interface 315 interfaces the processor 312 to peripherals (not shown) such as displays, keyboards and USB devices.

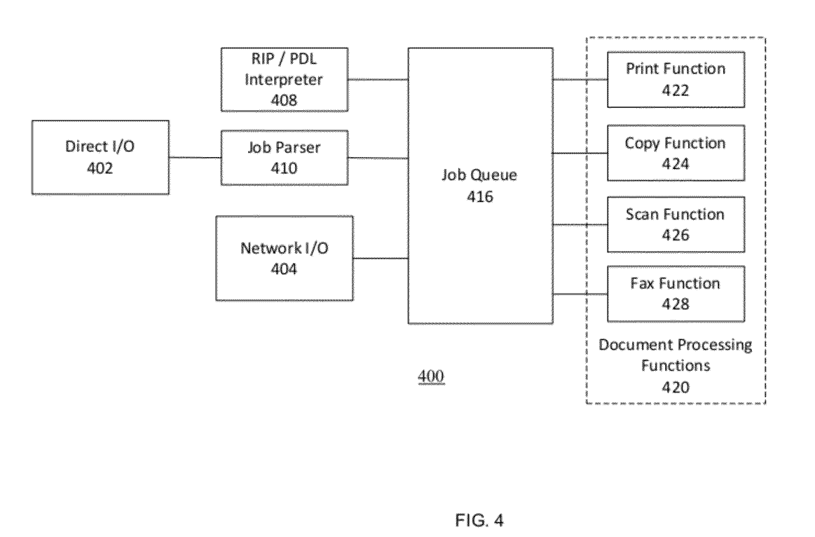

Turning now to FIG. 4 there is shown a block diagram of a software system 400 of an MFP which may operate on the controller 210 (FIG. 2.). The system 400 includes direct I/O 402, network I/O 404, a RIP/PDL interpreter 408, a job parser 410, a job queue 416, a series of document processing functions 420 including a print function 422, a copy function 424, a scan function 426 and a fax function 428.

The direct I/O 402 and the network I/O 404 provide input and output to the MFP controller. The direct I/O 402 is for the user interface on the MFP (e.g., user interface subsystem 113), and the network I/O 404 is for user interfaces over the network. This input and output may include documents for printing or faxing or parameters for MFP functions. In addition, the input and output may include control of other operations of the MFP. The network-based access via the client network I/O 404 may be accomplished using HTTP, FTP, UDP, electronic mail, TELNET, or other network communication protocols.

The RIP/PDL interpreter 408 transforms PDL-encoded documents received by the MFP into raster images or other forms suitable for use in MFP functions and output by the MFP. The RIP/PDL interpreter 408 processes the document and adds the resulting output to the job queue 416 to be output by the MFP.

The job parser 410 interprets a received document and relays it to the job queue 416 for handling by the MFP. The job parser 410 may perform functions of interpreting data received so as to distinguish requests for operations from documents and operational parameters or other elements of a document processing request.

The job queue 416 stores a series of jobs for completion using the document processing functions 420. Various image forms, such as bitmap, page description language or vector format may be relayed to the job queue 416 from the scan function 426 for handling. The job queue 416 is a temporary repository for all document processing operations requested by a user, whether those operations are received via the job parser 410, the client direct I/O 402 or the network I/O 404. The job queue 416 and associated software is responsible for determining the order in which print, copy, scan and facsimile functions are carried out. These may be executed in the order in which they are received, or may be influenced by the user, instructions received along with the various jobs or in other ways so as to be executed in different orders or in sequential or simultaneous steps. Information such as job control, status data, or electronic document data may be exchanged between the job queue 416 and users or external reporting systems.

The job queue 416 may also communicate with the job parser 410 in order to receive PDL files from the direct I/O 402. The direct I/O 402 may include printing, fax transmission or other input of a document for handling by the system 400.

The print function 420 enables the MFP to print documents and implements each of the various functions related to that process. These include stapling, collating, hole punching, and similar functions. The copy function 422 enables the MFP to perform copy operations and all related functions such as multiple copies, collating, 2 to 1 page copying or 1 to 2 page copying and similar functions. Similarly, the scan function 426 enables the MFP to scan and to perform all related functions such as shrinking scanned documents, storing the documents on a network or emailing those documents to an email address. The fax function 426 enables the MFP to perform facsimile operations and all related functions such as multiple number fax or auto-redial or network-enabled facsimile.

Some or all of the document processing functions 420 may be implemented on a client computer, such as a personal computer or thin client. The user interface for some or all document processing functions may be provided locally by the MFP's user interface subsystem though the document processing function is executed by a computing device separate from but associated with the MFP.

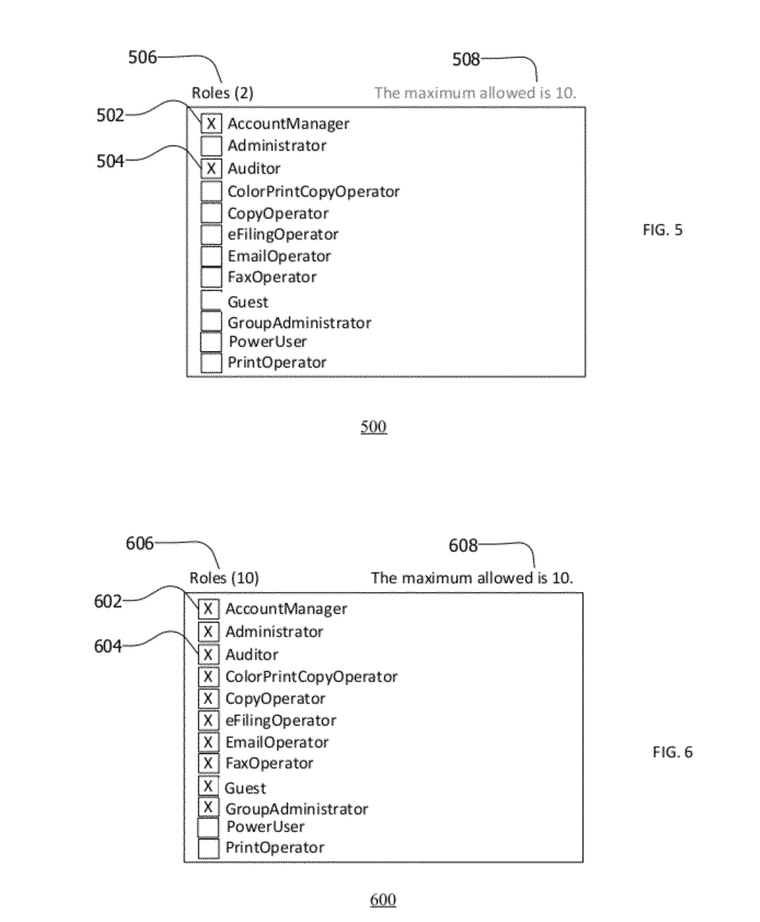

Turning now to FIG. 5 there is shown a exemplary count-constrained interface control 500. The count-constrained interface control 500 makes up a part of a user interface. The user interface may be implemented on an MFP, on a thin client associated with an MFP or as a part of an administrative program designed to operate in conjunction with an MFP.

The count-constrained interface control 500 enables users to input one of the count-constrained user roles via a series of checkboxes such as checkbox 502 and checkbox 504. The count-constrained interface control 500 provides a real-time update of the total count 506 of user roles that have been input. In FIG. 5 this total count 506 is limited to a count limit total of 10 roles for a user of a multifunction peripheral.

The count limit 508 is displayed to the user via a text-based interface element. This count limit 508 may be predetermined by an administrator. As may not be readily discernable from FIG. 5, the count limit 508 is displayed in a light grey text. This text instead may be identical to the default text for the interface.

Turning now to FIG. 6 there is shown a count-constrained interface control 600 after the maximum count has been reached. In this image, the checkbox 602, checkbox 604 and eight other checkboxes have been selected by the user. As a result, the maximum count of roles has been reached. The total count 606 is updated in real time to show that the maximum number of roles selection has been reached. In addition, the count limit 608 text color is changed. In FIG. 6, the color of the count limit 608 changed to a bright red. Other colors, highlighting, bolding, italics or other indicia of a count limit 608 may be used. However, the use of a color change enables the user to be notified with as little interruption to the user's ongoing work as possible. Once the user de-selects one option or reduces the total count 606 below the count limit 608, the text of the count limit 608 returns to normal.

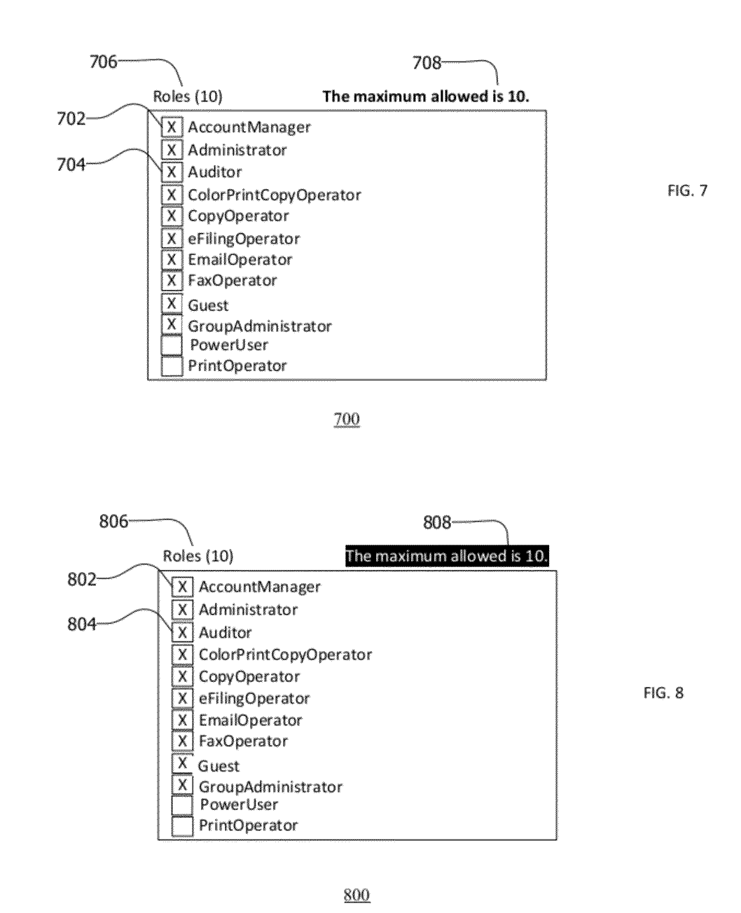

Turning now to FIG. 7 there is shown a count-constrained interface control once the count has been exceeded. FIG. 7 shows the same count-constrained interface control 700 of FIG. 6 in which checkbox 602, checkbox 604 and other checkboxes are selected. In FIG. 7, the total count 706 has exceeded the count limit 708. This occurs when the user has selected or attempts to select more than the count limit 708. As described above, any number of user inputs may be count constrained.

First, the count limit 608 appears in red text as shown in FIG. 6 (or is otherwise modified as described with reference to FIG. 6). Once a predetermined time period, such as one-half second passes, the count limit 708 is bolded as shown in FIG. 7. After another predetermined time period, such as another one-half second passes, the count limit 708 is un-bolded so as to appear as the count limit 608 (FIG. 6).

This may be repeated until the total count 706 is reduced below the maximum in instances in which the user is allowed to make more selections than the count limit 708. In situations in which the user is not allowed to make more selections than the count limit 708, this may be repeated only when the user attempts to select more than the count limit 708.

This change from FIG. 6 to FIG. 7 and back to FIG. 6 causes the count limit 708, 608 and 608, respectively, to appear to “blink” to the user. This is much less intrusive than other methods, while still ensuring that the user is aware of the count limit 608 and 708, respectively. The count limit 608 and 708 may continue to “blink” to a user until the user de-selects sufficient numbers of options or otherwise reduces the total count 606 and 706 to less than the count limit 608 and 708, respectively.

FIG. 8 shows an alternative count-constrained interface 800 control once the count has been exceeded. In this alternative count-constrained interface 800, the same checkbox 802, checkbox 804 and other checkboxes up to the total count 806 have been selected. As before, the count limit 808 is 10 roles.

In count-constrained interface 800, the text presented in the count-constrained interface 800 is inverted such that the text appears in white and the background for that text appears in black. This user interface may alternate between the count-constrained interface 800 and the count-constrained interface 600 (FIG. 6). In this way, the user may be alerted to the count limit 808, without significant interruption to the user's interaction with the interface element.

FIGS. 5-8 have described the count-constrained user interface 500, 600, 700 and 800 with regard to a series of count-constrained checkboxes for roles of MFP operators. However, the count constraint may also be total text character input into a text box, a number of selected files in a file management application, a limitation on a total number of items in a list, a limit on the number of files selected for upload in a user-interface element, or any other selection type that may be suitable for limitation by an administrator.

In addition, the types of dynamic alerts described have included altering the text color, bolding text, alternating between bold and normal text, inversion of text color and background color, and alternating the highlighting and non-highlighting of text. Other alternatives for alerting the user also exist. These include the addition of formatting such as underlining, bolding, italicizing and the like. They also include altering the size or font of the text. Additional alert mechanisms include highlighting the text in certain colors or shapes. In addition, the user's cursor or other interface element may be similarly altered by changing its shape, size, color, highlighting or similar characteristics in order to alert the user without interrupting the user's ongoing interaction with the element.

Description of Processes

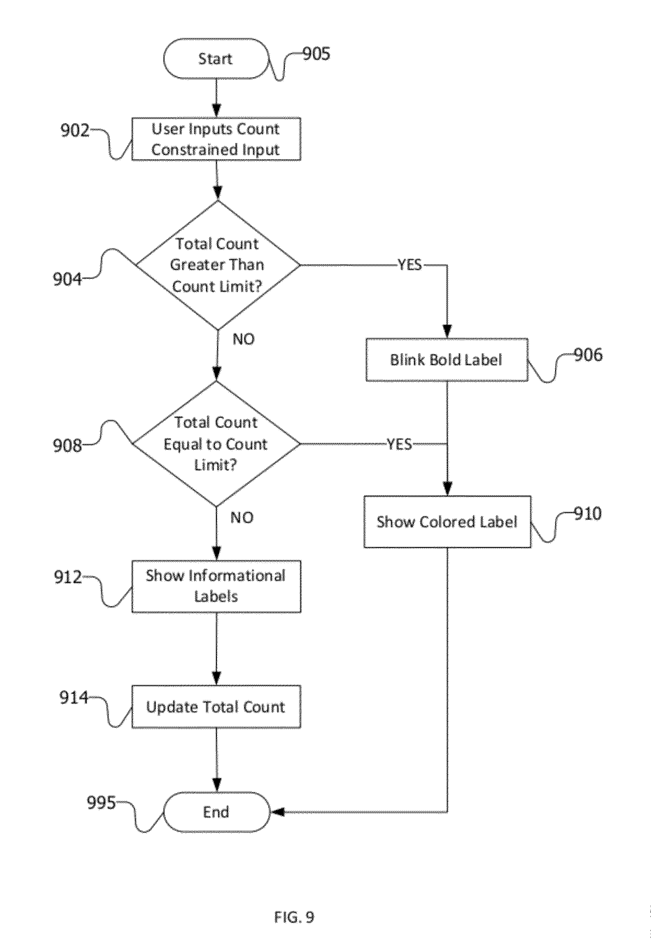

Turning now to FIG. 9, there is shown a flowchart for the operation of the count-constrained interface control. This may be implemented in a computing device (FIG. 3) or as a part of the software system for an MFP (FIG. 4). After the process start 905, the user inputs a count constrained input at 902. This count constrained input may be a total number of selections via checkbox or radio buttons, a total text count in a text box, a total number of selected files or a total number of selected options.

Next, it is determined whether or not the total count exceeds the count limit at 904. If so, the label associated with the count limit is “blinked” in bold at 906. This “blinking” will make the limitation imposed by the count constraint known to the user. Next, it is determined whether or not the total count is equal to the count limit at 908. If so, a colored label, such as a red label described above, is shown at 910. The label may be altered in other ways such as bolding, highlighting italics or otherwise altered to indicate that the count limit has been reached.

If the count limit has neither been exceeded or equaled by the total count, then informational labels are shown at 912. These labels correspond to the total count 506 and count limit 508, for example, shown in FIG. 5. The total count 506 is dynamically updated to show the total number of inputs by the user. When the total count 506 does not meet or exceed the count limit 508, the count limit 508 has no unique formatting or is formatted so as to de-emphasize its importance. In FIG. 5, the count limit 508 is shown in a grey text, lighter than the remainder of the user interface associated with the count-constrained interface control.

Finally, the total count is updated at 914. In this way, the total count is never allowed to exceed the count limit. Instead, the bold label is “blinked” at 906 or a colored label is shown at 910. Only if the total count is not already exceeded or equal to the count limit is the total count updated at 914 before the end of this flowchart is reached at 995.

The flow chart of FIG. 9 has both a start 905 and an end 995, but the process is cyclical in nature and may relate to one or more simultaneous instances of count-constrained input controls taking place in parallel or in serial.

Closing Comments

Throughout this description the embodiments and examples shown should be considered as exemplars, rather than limitations on the apparatus and procedures disclosed or claimed. Although many of the examples presented herein involve specific combinations of method acts or system elements, it should be understood that those acts and those elements may be combined in other ways to accomplish the same objectives. With regard to flowcharts, additional and fewer steps may be taken, and the steps as shown may be combined or further refined to achieve the methods described herein. Acts, elements and features discussed only in connection with one embodiment are not intended to be excluded from a similar role in other embodiments.

As used herein, “plurality” means two or more. As used herein, a “set” of items may include one or more of such items. As used herein, whether in the written description or the claims, the terms “comprising”, “including”, “carrying”, “having”, “containing”, “involving”, and the like are to be understood to be open-ended, i.e., to mean including but not limited to. Only the transitional phrases “consisting of and “consisting essentially of”, respectively, are closed or semi-closed transitional phrases with respect to claims. Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements. As used herein, “and/or” means that the listed items are alternatives, but the alternatives also include any combination of the listed items.

It is claimed:

1. A method for providing a user interface comprising:
displaying a user input field and a predetermined count limit of user input parameters for the user input field on a user interface on a display;
receiving a user input parameter into the user input field;
maintaining a total count of user input parameters; and
updating the user interface such that the predetermined count limit (a) blinks if the total count of user input parameters exceeds the predetermined count limit, (b) changes color if the total count of user input parameters equals the predetermined count limit, and (c) returns to a default color matching other aspects of the user interface if the total count of user input parameters is less than the predetermined count limit.

2. The method of claim 1 wherein the predetermined count limit is set by a user administrator.

3. The method of claim 1 wherein the predetermined count limit blinks on the display by alternating from colored text to bold colored text and then to colored text a predetermined number of times.

4. The method of claim 3 wherein the predetermined count limit blinks on the display by alternating from colored text to bold colored text and then to colored text while waiting a predetermined period of time between each alternation.

5. The method of claim 1 wherein the total count is a total number of user selections.

6. The method of claim 1 wherein the total count is a total number of user input characters.

7. A multifunction peripheral, including a processor and associated memory, the multifunction peripheral including software that when executed by the processor causes the multifunction peripheral to:
display a user input field and a predetermined count limit of user input parameters for the user input field on a user interface on a display;
receive a user input parameter into the user input field;
maintain a total count of user input parameters; and
update the user interface such that the predetermined count limit (a) blinks if the total count of user input parameters exceeds the predetermined count limit, (b) changes color if the total count of user input parameters equals the predetermined count limit, and (c) returns to a default color matching other aspects of the user interface if the total count of user input parameters is less than the predetermined count limit.

8. The multifunction peripheral of claim 7 wherein the predetermined count limit is set by a user administrator.

9. The multifunction peripheral of claim 7 wherein the predetermined count limit blinks on the display by alternating from colored text to bold colored text and then to colored text a predetermined number of times.

10. The multifunction peripheral of claim 9 wherein the predetermined count limit blinks on the display by alternating from colored text to bold colored text and then to colored text while waiting a predetermined period of time between each alternation.

11. The multifunction peripheral of claim 7 wherein the total count is a total number of user selections.

12. The multifunction peripheral of claim 7 wherein the total count is a total number of user input characters.

13. Apparatus comprising a storage medium storing a program having instructions which when executed by a processor will cause the processor to:
display a user input field and a predetermined count limit of user input parameters for the user input field on a user interface on a display;
receive a user input parameter into the user input field;
maintain a total count of user input parameters; and
update the user interface such that the predetermined count limit (a) blinks if the total count of user input parameters exceeds the predetermined count limit, (b) changes color if the total count of user input parameters equals the predetermined count limit, and (c) returns to a default color matching other aspects of the user interface if the total count of user input parameters is less than the predetermined count limit.

14. The apparatus of claim 13 wherein the predetermined count limit is set by a user administrator.

15. The apparatus of claim 13 wherein the predetermined count limit blinks on the display by alternating from colored text to bold colored text and then to colored text a predetermined number of times.

16. The apparatus of claim 15 wherein the predetermined count limit blinks on the display by alternating from colored text to bold colored text and then to colored text while waiting a predetermined period of time between each alternation.

17. The apparatus of claim 13 wherein the total count is a total number of user selections.

18. The method of claim 13 wherein the total count is a total number of user input characters.
